(19) United States
(12) Patent Application Publication
(10) Pub. No.: US 2024/0241932 A1
(43) Pub. Date: Jul. 18, 2024

(54) INFORMATION PROCESSING SYSTEM, RESOURCE MANAGEMENT APPARATUS, RESOURCE MANAGEMENT METHOD AND PROGRAM

(71) Applicant: NIPPON TELEGRAPH AND TELEPHONE CORPORATION, Tokyo (JP)

(72) Inventors: Ryohei SUZUKI, Tokyo (JP); Koji CHIDA, Tokyo (JP); Tetsuya OKUDA, Tokyo (JP)

(21) Appl. No.: 18/558,449

(22) PCT Filed: Jun. 8, 2021
(86) PCT No.: PCT/JP2021/021784

§ 371 Date: Nov. 1, 2023

(51) Int. Cl. G06F 21/31

(52) U.S. Cl. CPC G06F 21/31

(57) ABSTRACT

In an information processing system including: a resource management device that manages certain resources; an access device that accesses the resources; and an authorizing device that issues, to the access device, an access token corresponding to an access authority to the resources in a case where delegation of the access authority is permitted by an owner of the resources, the resource management device includes: an acquisition unit that acquires, in response to an access request to the resources accompanied by the access token from the access device, information in which a modifier is given to an access authority disclosed in advance by the authorizing device, which serves as information indicating a range of the access authority corresponding to the access token; and an execution unit that executes processing according to the access request within the range of the access authority limited by the modifier, thereby improving the flexibility of the range of an authority to be delegated to another person.

### TECHNICAL FIELD

The present invention relates to an information processing system, a resource management device, a resource management method, and a program.

### BACKGROUND ART

As a technical specification for delegation of a partial authority to another person, OAuth is known (Non Patent Literature 1 and Non Patent Literature 2).

As players (roles) related to OAuth, there are a resource owner (RO), a resource server (RS), a relining party (RP), and an authorizing server (AS). The RO is an owner of resources such as data, and is a user who uses the resources via a certain service provided by a third party. The RS is a manager of the resources of the RO (generally, management entities of the AS and the RS are the same). The RP is the third party that provides the certain service. When the service is provided, the RO delegates his/her authority to the RP, and the RP accesses the resources managed by the RS on behalf of the RO. The AS delegates an authority to access the resources to the RP.

Specifically, first, the RO uses the service of the RP. At this time, the RO selects cooperation between the AS and the RP (the RO selects cooperation between the RP and the AS in a state of accessing the RP). The RO is redirected from the RP to the AS and authorizes cooperation with the RP on the AS (agrees to delegate his/her authority). As a result, the RP can obtain an access token necessary for accessing the resources managed by the RS.

In OAuth, an authority to be delegated to another person is called a scope. The AS designs what types of authorities can be delegated, and discloses the authorities by API reference or the like. The RP selects an authority to be used to provide the service from the API reference. The RO checks the authority requested by the RP and, if the RO agrees, delegates his/her own authority to the RP.

### CITATION LIST

### Non Patent Literature

Non Patent Literature 1: The OAuth 2.0 Authorization Framework (RFC6749), [online], Internet <URL:https://tools.ietf.org/html/rfc6749>
Non Patent Literature 2: The OAuth 2.0 Authorization Framework: Bearer Token Usage (RFC6750), [online], Internet <URL:https://tools.ietf.org/html/rfc6750>

### SUMMARY OF INVENTION

### Technical Problem

However, in the above-described conventional technique, only a scope initially designed by the AS is designated, and thus there is a possibility that a greater authority than necessary may be delegated to the RP for the service provided by the RP.

The present invention has been made in view of the above points, and an object thereof is to improve the flexibility of the range of an authority to be delegated to another person.

### Solution to Problem

Therefore, in order to solve the above problem, in an information processing system including: a resource management device that manages certain resources; an access device that accesses the resources; and an authorizing device that issues, to the access device, an access token corresponding to an access authority to the resources in a case where delegation of the access authority is permitted by an owner of the resources, the resource management device includes: an acquisition unit that acquires, in response to an access request to the resources accompanied by the access token from the access device, information in which a modifier is given to an access authority disclosed in advance by the authorizing device, which serves as information indicating a range of the access authority corresponding to the access token; and an execution unit that executes processing according to the access request within the range of the access authority limited by the modifier.

### Advantageous Effects of Invention

It is possible to improve the flexibility of the range of an authority to be delegated to another person.

### BRIEF DESCRIPTION OF DRAWINGS

FIG. 1 is a diagram illustrating a configuration example of an information processing system according to an embodiment of the present invention.

FIG. 2 is a diagram illustrating a hardware configuration example of a resource server 10 according to the embodiment of the present invention.

FIG. 3 is a diagram illustrating a functional configuration example of the information processing system according to the embodiment of the present invention.

FIG. 4 is a sequence diagram for describing an example of a processing procedure at the time of issuing an access token.

FIG. 5 is a diagram illustrating a display example of a screen inquiring of a user whether to permit cooperation with an authorizing server 20.

FIG. 6 is a diagram illustrating an example in which a menu on the screen inquiring of the user whether to permit cooperation with the authorizing server 20 is expanded.

FIG. 7 is a diagram illustrating a display example of a screen inquiring whether or not an authority can be delegated.

FIG. 8 is a diagram illustrating an example in which a menu on the screen inquiring whether or not the authority can be delegated is expanded.

FIG. 9 is a diagram conceptually illustrating the size (range) of a scope.

FIG. 10 is a flowchart for describing an example of a processing procedure at the time of using an access token.

### DESCRIPTION OF EMBODIMENTS

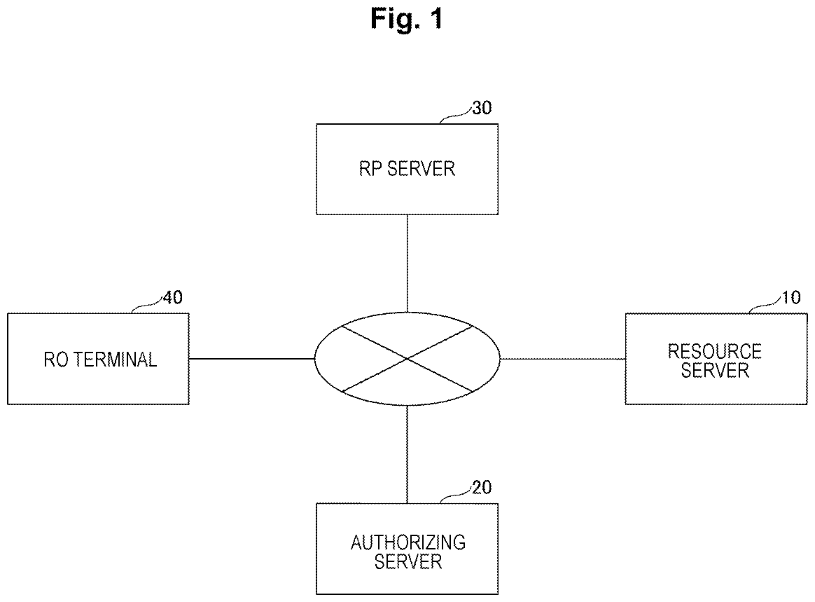

Hereinafter, an embodiment of the present invention will be described with reference to the drawings. FIG. 1 is a diagram illustrating a configuration example of an information processing system according to the embodiment of the present invention.

In FIG. 1, an RO terminal 40, an RP server 30, an authorizing server 20, and a resource server 10 are connected via a network such as the Internet.

The RO terminal 40 is a terminal used by a user who is an owner of certain software resources such as data (hereinafter, referred to as the “target resources”) and a user of a certain service that accesses the target resources (hereinafter, referred to as the “target service”). For example, a personal computer (PC), a smartphone, a tablet terminal, or the like may be used as the RO terminal 40. Note that the user corresponds to a resource owner (RO) in OAuth.

The RP server 30 is one or more computers that provide the target service. In order to provide the target service, the RP server 30 executes processing for receiving an authority to access the target resources to be delegated from the RO. The processing conforms to OAuth. Note that the RP server 30 functions as a relaying party (RP) in OAuth.

The authorizing server 20 is one or more computers that function as an AS in OAuth.

The resource server 10 is one or more computers that store and manage the target resources and function as an RS in OAuth.

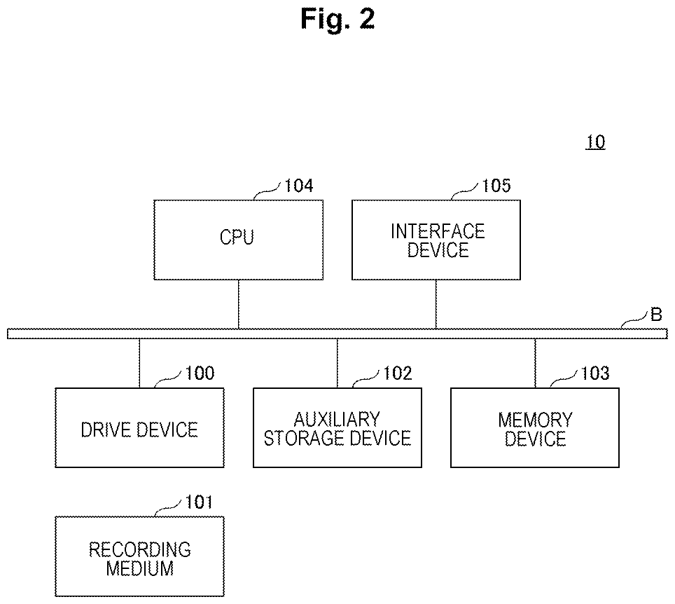

FIG. 2 is a diagram illustrating a hardware configuration example of the resource server 10 according to the embodiment of the present invention. The resource server 10 of FIG. 2 includes a drive device 100, an auxiliary storage device 102, a memory device 103, a CPU 104, an interface device 105, and the like, which are connected to each other by a bus B.

A program for implementing processing in the resource server 10 is provided by a recording medium 101 such as a CD-ROM. When the recording medium 101 storing the program is set in the drive device 100, the program is installed from the recording medium 101 to the auxiliary storage device 102 via the drive device 100. However, the program is not necessarily installed from the recording medium 101, and may be downloaded from another computer via a network. The auxiliary storage device 102 stores the installed program and also stores necessary files, data, and the like.

In a case where an instruction to start the program is made, the memory device 103 reads the program from the auxiliary storage device 102 and stores the program. The CPU 104 executes a function related to the resource server 10 according to the program stored in the memory device 103. The interface device 105 is used as an interface for connecting to a network.

Note that each of the RP server 30, the authorizing server 20, and the RO terminal 40 may also have a hardware configuration similar to that of FIG. 2.

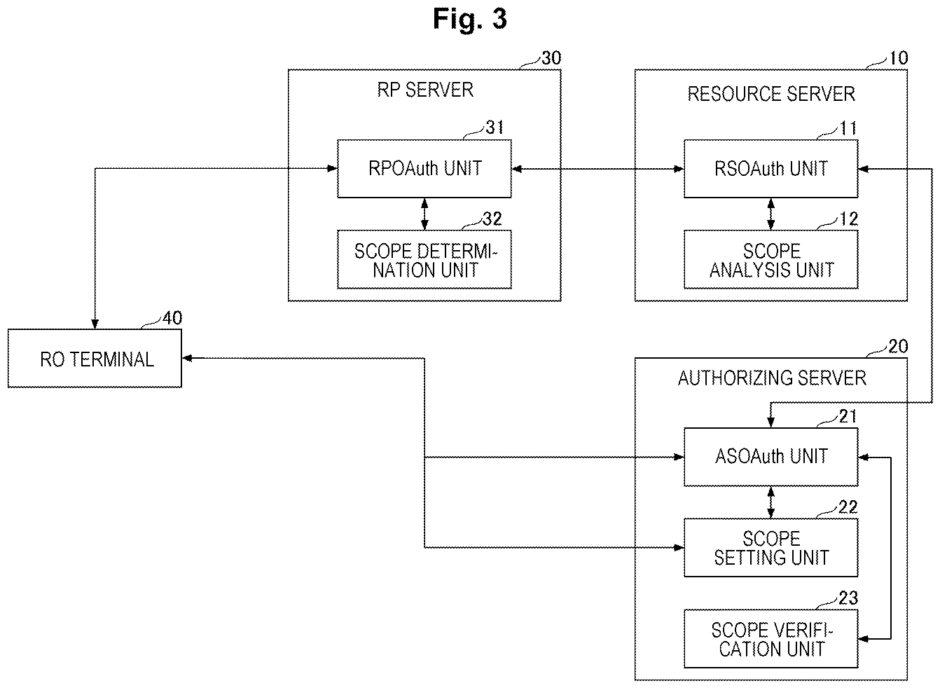

FIG. 3 is a diagram illustrating a functional configuration example of the information processing system according to the embodiment of the present invention. In FIG. 3, the RP server 30 includes an RPOAuth unit 31 and a scope determination unit 32. Each of these units is implemented by processing executed by a CPU of the RP server 30 by one or more programs installed in the RP server 30.

The authorizing server 20 includes an ASOAuth unit 21, a scope setting unit 22, and a scope verification unit 23. Each of these units is implemented by processing executed by a CPU of the authorizing server 20 by one or more programs installed in the authorizing server 20.

The resource server 10 includes an RSOAuth unit 11 and a scope analysis unit 12. Each of these units is implemented by processing executed by the CPU 104 by one or more programs installed in the resource server 10.

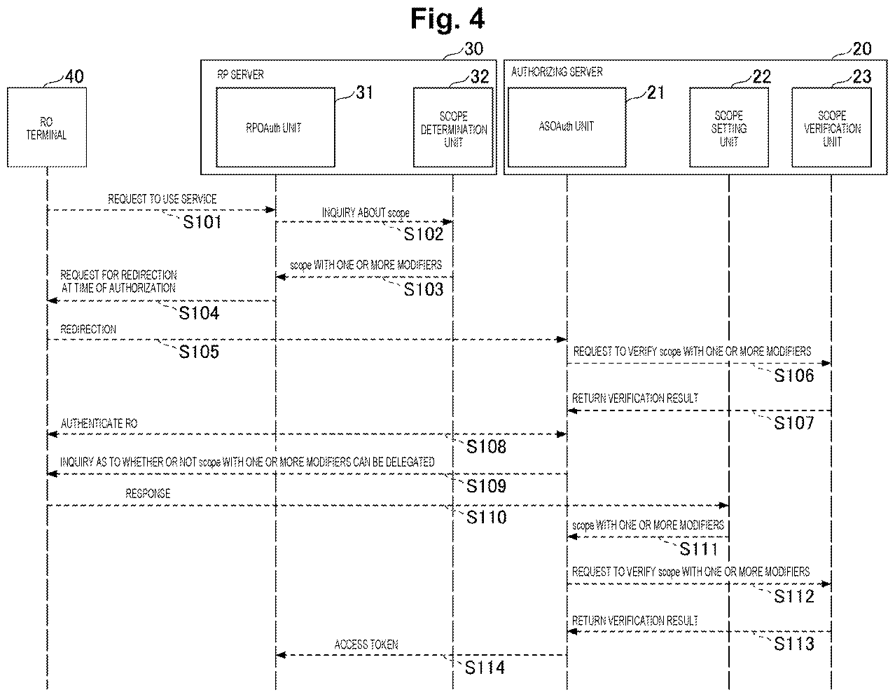

Hereinafter, a processing procedure executed by the information processing system will be described. FIG. 4 is a sequence diagram for describing an example of a processing procedure at the time of issuing an access token. Note that the processing procedure of FIG. 4 conforms to OAuth. In addition, processing executed by the RO terminal 40 in FIG. 4 is, for example, processing that a web browser installed in the RO terminal 40 causes the RO terminal 40 to execute.

In step S101, the RO terminal 40 transmits a request to use the target service to the RP server 30 according to a predetermined operation by the user. Note that it is assumed that the user is authenticated by the RP server 30. Therefore, it is assumed that the RP server 30 can specify the user as a request source of the use request.

Upon receiving the use request, the RPOAuth unit 31 of the RP server 30 inquires of the scope determination unit 32 a value of a scope necessary for the target service (S102). The scope corresponds to a scope in OAuth. The scope in OAuth corresponds to an authority to be delegated to another person. Values that can be designated in the scope (that is, ranges or types of authorities) are disclosed in advance by the authorizing server 20 through API reference or the like. Hereinafter, a list of values of the scope disclosed in advance by the authorizing server 20 will be referred to as the “predetermined list”.

The scope determination unit 32 determines the scope necessary for the target service in response to the inquiry by the RPOAuth unit 31. The determination by the scope determination unit 32 is performed on the basis of setting information set in advance and stored in the auxiliary storage device 102 or the like. That is, the setting information indicates the scope necessary for the target service. The setting information indicates a scope that is applied for to the AS at the time of registration application of the RP itself to the AS (application for registration of an account of a developer of the service of the RP), which is required for OAuth. That is, the application requires information such as cooperation destination information (information regarding the RP), a display name, a contact address, and an authority=a scope desired to be delegated from a user. Note that the RP can use OAuth only in a case where the AS permits the application.

In the present embodiment, it is possible to set, as the setting information, contents that further limit the range of access authority related to any scope in the predetermined list. In a case where a certain value in the predetermined list is further limited, the value is given an identifier indicating limitation contents (hereinafter, such an identifier will be referred to as a “modifier”). As examples of a modifier, for example, the following modifiers are considered.

### (a) Modifier Related to Structural Relationship (Parent-Child Relationship or the Like) of Resources

For example, if the resources are photographs, a modifier of
{scope}.{album_name}
   is considered. Here, {scope} is a value in the predetermined list, and “.{album_name}” indicates a modifier. The modifier means to limit access only to photographs in a particular album according to album_name.
   (b) Modifier Related to Period in which Resources are Generated

For example, a modifier of scope.{YYYY/MM/DD}

is considered. The modifier means to limit access only to resources generated on a specific date (YYYY/MM/DD).
The period in which the resources are generated may be limited by
scope.{YYYY/MM/DD-YYYY/MM/DD}.
   At this time, “MM/DD” or “DD” may be omitted.

For example, assuming that “photo” is one scope in the predetermined list indicating an authority to access all the photographs, a setting such as “photo.span2020-2021” is possible. Here, the “span2020-2021” means a modifier that limits a period in which photographs are taken. Therefore, “scope=photo.span2020-2021” indicates an access authority limited only to the photographs taken in the period of 2020 to 2021.

(c) Location where Resources are Generated

For example, a modifier of {scope}.{building name, prefecture name, or the like} is considered. The modifier means to limit the access authority only to resources related to a specific location.

Note that, as described above, it is necessary to apply for a scope at the time of registration application of the RP, but in the present embodiment, it is assumed that it is possible to apply for a scope with a modifier (hereinafter, such a scope will be referred to as a “scope with one or more modifiers”), and a scope with one or more modifiers is applied for. Therefore, the scope determination unit 32 responds to the RPOAuth unit 31 with the scope with one or more modifiers that has been applied for (S103).

Subsequently, the RPOAuth unit 31 responds to the RO terminal 40 with a request to redirect an authorization request including the scope with one or more modifiers (S104). Specific contents of the redirection request are, for example, as follows.
“HTTP/1.1 302 Moved Temporarily Location: https://[authorized endpoint of AS (public information)]/authorize?response_type=code&scope=photo&client_id= . . . ”

As described above, in the present embodiment, the redirection request can include a scope as a parameter.

The RO terminal 40 that has received the response displays a screen for inquiring of the user whether to permit the RP server 30 to cooperate with the authorizing server 20.

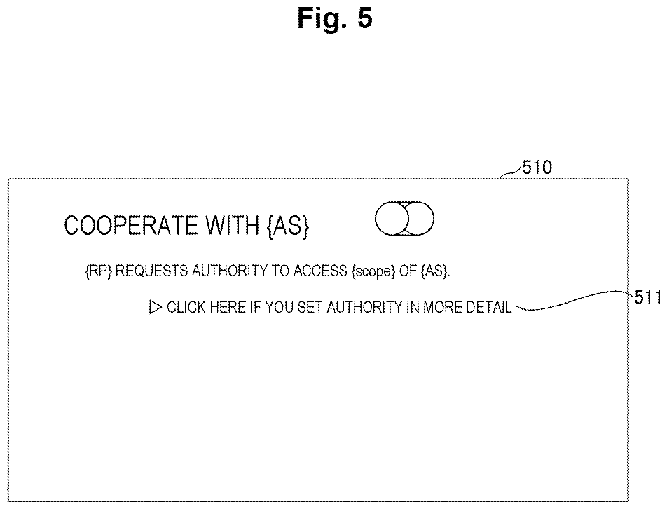

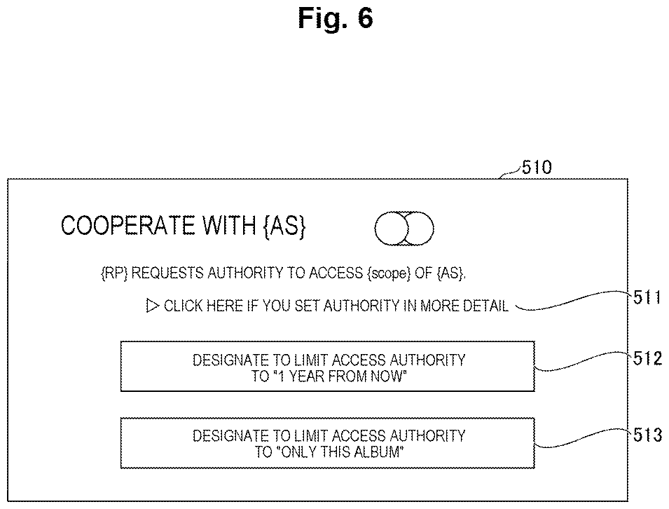

FIG. 5 is a diagram illustrating a display example of the screen inquiring of the user whether to permit cooperation with the authorizing server 20. In a screen 510 illustrated in FIG. 5, a portion surrounded by { } is actually replaced with a specific service name or the like. The screen 510 includes a menu 511. When the menu 511 is clicked by the user, the state of the screen 510 becomes as illustrated in FIG. 6.

In FIG. 6, a possibility 513 and a possibility 514, which are possible modifiers to be further given to the scope with one or more modifiers included in the redirection request, are displayed as options. The possibilities may be modifiers other than the modifier already given to the scope in a list of modifiers that can be given to the original scope of the scope with one or more modifiers. In a case where the user desires to limit the authority to be delegated to the RP server 30 by his/her own will, the user selects one possibility and thus can limit the authority according to the possibility.

When an operation indicating permission for the cooperation with the authorizing server 20 is performed via the screen 510, the RO terminal 40 redirects the authorization request including the scope with one or more modifiers to the authorizing server 20 in response to the redirection request (S105). Note that, in a case where addition of a modifier is selected by the user via the screen 510 (in a case where any of the possible modifiers is selected), the scope with one or more modifiers is further given the added modifier.

When the redirected authorization request is received and the scope included in the authorization request is a scope with one or more modifiers, the ASOAuth unit 21 of the authorizing server 20 transmits a request to verify the scope with one or more modifiers to the scope verification unit 23 (S106). The scope verification unit 23 verifies the scope with one or more modifiers in response to the verification request. For example, it is verified whether the scope is a scope that is permitted to be given a modifier, and it is verified whether the value of the modifier is correct. That is, whether or not a modifier can be given, modifiers that can be given, and the like are defined in advance for each scope. Subsequently, the scope verification unit 23 transmits the verification result (OK or NG) to the ASOAuth unit 21 (S107). If the verification result is OK, step S108 and subsequent steps are executed, and if the verification result is NG, step S108 and subsequent steps are not executed.

In step S108, the ASOAuth unit 21 executes authentication processing of the user of the RO terminal 40 (that is, the RO of the target resources) according to a conventional OAuth procedure. When the authentication succeeds, the ASOAuth unit 21 transmits, to the RO terminal 40, an inquiry as to whether or not the authority indicated by the scope with one or more modifiers can be delegated (S109).

In response to the inquiry, the RO terminal 40 displays a screen inquiring whether or not the authority can be delegated.

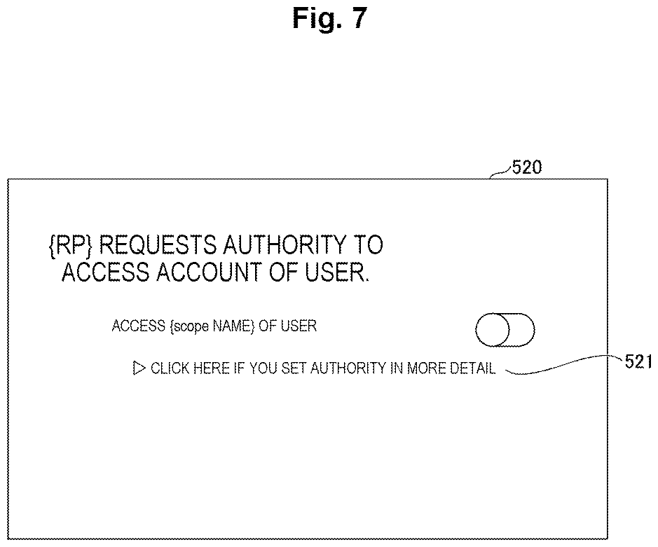

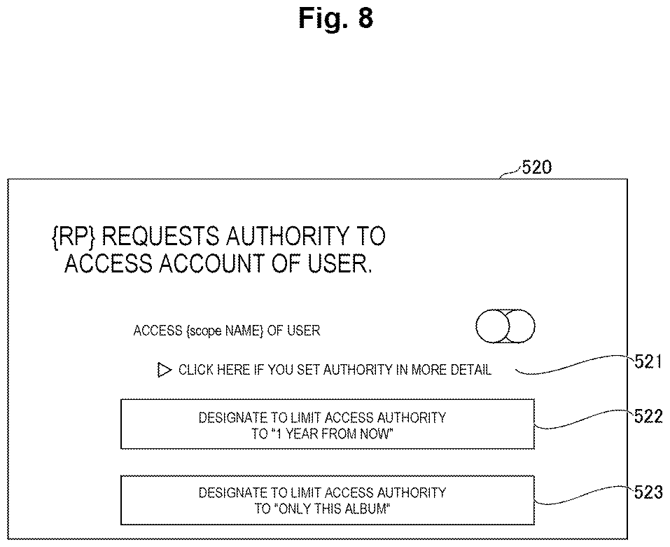

FIG. 7 is a diagram illustrating a display example of the screen inquiring whether or not the authority can be delegated. In a screen 520 illustrated in FIG. 7, a portion surrounded by { } is actually replaced with a specific service name or the like. The screen 520 includes a menu 521. When the menu 521 is clicked by the user, the state of the screen 520 becomes as illustrated in FIG. 8.

In FIG. 8, a possibility 523 and a possibility 524, which are possible modifiers to be further given to the scope with one or more modifiers indicating the authority, are displayed as options. The possibilities may be modifiers other than the modifier already given to the scope in a list of modifiers that can be given to the original scope of the scope with one or more modifiers. In a case where the user desires to limit the authority of the user, the user selects one possibility and thus can limit the authority according to the possibility.

When an operation indicating permission for the delegation of the authority to the RP server 30 is performed via the screen 520, the RO terminal 40 transmits a response indicating the permission for the delegation of the authority to the authorizing server 20 (S110). The response also includes the scope with one or more modifiers. The scope with one or more modifiers is the same as that transmitted to the RO terminal 40 in step S109 in a case where the user adds no modifier via the screen 520, and is the scope to which an added modifier is further given in a case where the user adds the modifier via the screen 520.

Upon receiving the response, the scope setting unit 22 of the authorizing server 20 sets the scope with one or more modifiers included in the response in the ASOAuth unit 21 (S111). In a case where the set scope with one or more modifiers is changed from the scope with one or more modifiers verified in step S106 (in a case where a modifier is added), the ASOAuth unit 21 transmits a request to verify the set scope with one or more modifiers to the scope verification unit 23 (S112). The scope verification unit 23 verifies the scope with one or more modifiers in response to the verification request. The contents of the verification may be the same as those according to the verification request in step S106. Subsequently, the scope verification unit 23 transmits the verification result (OK or NG) to the ASOAuth unit 21 (S113). If the verification result is OK, step S114 is executed, and if the verification result is NG, step S114 is not executed.

In step S114, the ASOAuth unit 21 issues (transmits) an access token for the target resources to the RPOAuth unit 31 according to a procedure specified in OAuth. Note that S114 means a procedure for issuing an access token to the RP server 30, and the procedure is replaced with a specific processing procedure according to a grant type of OAuth. With the issuance of the access token, the ASOAuth unit 21 stores the scope with one or more modifiers corresponding to the access token. The method for storing the scope with one or more modifiers corresponding to the access token may conform to a method for storing a scope corresponding to an access token in OAuth.

The RP can access the target resources by using the access token (hereinafter, referred to as the “target token”).

Note that, in FIG. 4, the scope can be limited (a modifier can be given to the scope) at the following three timings in the process before the access token is issued.
(0) Timing at presentation of the scope when the RP registers with the AS

As a result, a response is made with the scope with one or more modifiers in step S103.
(1) Timing at which the RP server 30 makes an authorization request when the user uses the service of the RP server 30

The user limits the scope (gives a modifier to the scope) via the screen 510.
(2) Timing at which the user authorizes the authority presented by the RP via the authorizing server 20

The user limits the scope (gives a modifier to the scope) via the screen 520.

However, it is not intended that a modifier needs to be able to be given at all timings of (0) to (2) described above, and it is sufficient that a modifier can be given at any one or more of the timings.

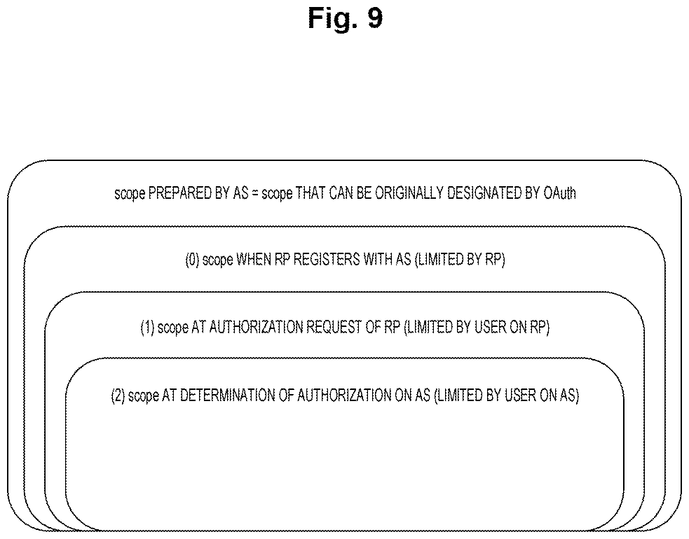

Note that, in a case where the scope can be limited at three timings as described above, the size (range) of the scope can be limited at multiple stages as illustrated in FIG. 9.

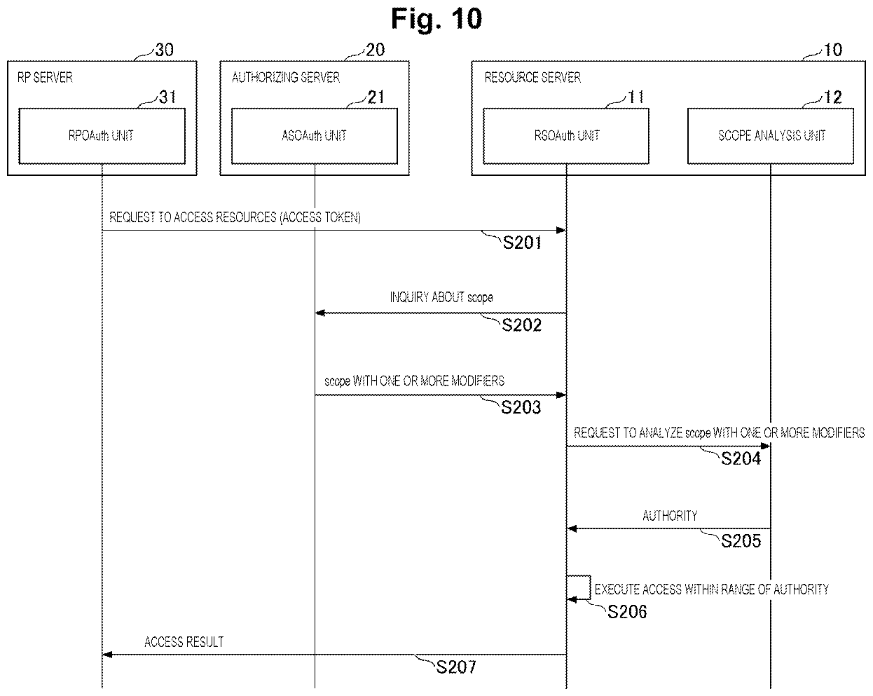

Next, use of an access token will be described. FIG. 10 is a flowchart for describing an example of a processing procedure at the time of using an access token. The processing procedure of FIG. 10 is executed, for example, following step S114 of FIG. 4.

In step S201, the RPOAuth unit 31 transmits, to the resource server 10, a request to access the target resources with the target token, which is a procedure conforming to OAuth.

Upon receiving the access request and the target token, the RSOAuth unit 11 of the resource server 10 transmits an inquiry about a scope corresponding to the target token to the ASOAuth unit 21, which is a procedure conforming to OAuth (S202). The inquiry includes the target token.

In response to the inquiry, the ASOAuth unit 21 transmits a response including the scope stored in association with the target token to the RSOAuth unit 11 (S203). In the present embodiment, the response includes the scope with one or more modifiers. Specific contents of the response are, for example, as follows.
“HTTP 200 OK Content-type:application/json {“scope”:“scope.{album_name} scope.{YYYY-MM-DD}”, . . . }”

That is, in the response, the scopes corresponding to the target token are arranged, and modifiers are given to the scopes.

The RSOAuth unit 11 receives the response to acquire the scope with one or more modifiers included in the response. Subsequently, the RSOAuth unit 11 transmits a request to analyze the meaning (authority) of the scope with one or more modifiers to the scope analysis unit 12 together with the scope with one or more modifiers (S204). The scope analysis unit 12 analyzes the meaning of the scope with one or more modifiers in response to the analysis request, and transmits, to the RSOAuth unit 11, a response including the access authority indicated by the scope with one or more modifiers as an analysis result (S205). In the present embodiment, a response is made with the access authority limited by the one or more modifiers. For example, when the scope with one or more modifiers is “scope=photo.span2020-2021”, a response indicating that the access authority is only for the photographs taken in the period from 2020 to 2021 is transmitted.

Subsequently, the RSOAuth unit 11 executes processing according to the access request from the RPOAuth unit 31 (access to the target resources) within the range of the access authority (S206). As a result, the authority of the RPOAuth unit 31 is limited on the basis of the one or more modifiers.

Subsequently, the RSOAuth unit 11 transmits a result of access to the target resources to the RPOAuth unit 31 (S207).

As described above, according to the present embodiment, giving a modifier to a scope makes it possible to limit the range of authority of the original scope. Therefore, it is possible to improve the flexibility of the range of an authority to be delegated to another person. As a result, an authority to be de delegated can be limited to a range necessary for a service.

In addition, since a user can give a modifier, it is possible to perform limitation of an authority advantageous to the user. As a result, it is possible to increase the possibility of avoiding delegation of an authority not intended by the user.

Note that, in the present embodiment, the resource server 10 is an example of a resource management device. The authorizing server 20 is an example of an authorizing device. The RP server 30 is an example of an access device. The RSOAuth unit 11 is an example of an acquisition unit and an execution unit.

Although the embodiment of the present invention has been described in detail above, the present invention is not limited to such a specific embodiment, and various modifications and changes can be made within the scope of the gist of the present invention described in the claims.

### REFERENCE SIGNS LIST

| | |
|---|---|
| 10 | Resource server |
| 11 | RSOAuth unit |
| 12 | Scope analysis unit |
| 20 | Authorizing server |
| 21 | ASOAuth unit |
| 22 | Scope setting unit |
| 23 | Scope verification unit |
| 30 | RP server |
| 31 | RPOAuth unit |
| 32 | Scope determination unit |
| 40 | RO terminal |
| 100 | Drive device |
| 101 | Recording medium |
| 102 | Auxiliary storage device |
| 103 | Memory device |
| 104 | CPU |
| 105 | Interface device |
| B | Bus |

1. An information processing system comprising:
a resource management device that manages certain resources;
an access device that accesses the resources; and
an authorizing device that issues, to the access device, an access token corresponding to an access authority to the resources in a case where delegation of the access authority is permitted by an owner of the resources,
the resource management device including:
a processor; and
a memory storing program instructions that cause the processor to:
acquire, in response to an access request to the resources accompanied by the access token from the access device, information in which a modifier is given to an access authority disclosed in advance by the authorizing device, which serves as information indicating a range of the access authority corresponding to the access token; and
execute processing according to the access request within the range of the access authority limited by the modifier.

2. The information processing system according to claim 1, wherein the modifier is given by the access device before the access token is issued to the access device.

3. The information processing system according to claim 1, wherein the modifier is given by the owner of the resources before the access token is issued to the access device.

4. A resource management device that manages certain resources, the resource management device comprising:
a processor; and
a memory storing program instructions that cause the processor to:
acquire, in response to an access request to the resources accompanied by an access token corresponding to an access authority to the resources issued from an authorizing device in a case where delegation of the access authority is permitted by an owner of the resources, information in which a modifier is given to an access authority published in advance by the authorizing device, which serves as information indicating a range of the access authority corresponding to the access token; and
execute processing according to the access request within the range of the access authority limited by the modifier.

5. A resource management method executed by a resource management device that manages certain resources, the resource management method comprising:
acquiring, in response to an access request to the resources accompanied by an access token corresponding to an access authority to the resources issued from an authorizing device in a case where delegation of the access authority is permitted by an owner of the resources, information in which a modifier is given to an access authority published in advance by the authorizing device, which serves as information indicating a range of the access authority corresponding to the access token; and
executing processing according to the access request within the range of the access authority limited by the modifier.

6. A non-transitory computer-readable recording medium having stored therein a program for causing a resource management device that manages certain resources to perform the resource management method according to claim 5.
